(19) United States
(12) Patent Application Publication
(10) Pub. No.: US 2012/0273142 A1
(43) Pub. Date: Nov. 1, 2012

(54) Manual Drive Mechanism for Rolling Protective Shutters

(75) Inventors: James V. Miller, Glen Ellyn, IL (US); Brian Peterson, Glen Ellyn, IL (US)

(73) Assignee: Qualitas Manufacturing, Inc., Itasca, IL (US)

(21) Appl. No.: 13/195,572

(22) Filed: Aug. 1, 2011

Related U.S. Application Data
(63) Continuation-in-part of application No. 13/096,515, filed on Apr. 28, 2011.

(51) Int. Cl. E06B 9/58

(52) U.S. Cl. 160/309

(57) ABSTRACT

The present invention is directed to a rolling protective shutter having an improved manual drive mechanism. The improved manual drive mechanism may include a hand crank pole having a female connector that demountably attaches to a male connector of the rolling protective shutter to rotate a drive shaft. The female connector may be attached to the hand crank pole by a universal joint so that the female connector may pivot relative to the hand crank pole. A resilient alignment mechanism, such as an elastomeric sleeve or coil spring, may be disposed on and engage the universal joint to axially align the female connector with the hand crank pole while allowing the female connector to pivot relative to the elongated pole section when a force is applied.

### CROSS-REFERENCE TO RELATED APPLICATION

This application is a Continuation-In-Part (CIP) Patent Application of U.S. application Ser. No. 13/096,515, filed on Apr. 28, 2011, which applicantion is expressly incorporated by reference herein.

### BACKGROUND

The present invention is directed to a rolling protective shutter assembly which has a shutter curtain for covering a window or door opening that may be rolled up into a shutter housing when not in use, and in particular to a manually-driven shutter assembly having an improved manual drive mechanism for rolling and unrolling the shutter curtain.

Rolling protective shutters are conventional and are used to provide protection against extreme weather conditions and to deter theft, for example. One such rolling protective shutter is disclosed in U.S. Pat. No. 6,095,224 to Miller. Referring to FIG. 1 of the present application, which illustrates a shutter assembly 10 similar to that disclosed in the Miller patent, the assembly 10 includes a shutter housing having a top wall 12, a pair of side walls or end caps 14, a front wall 16, a rear wall 18 and a bottom wall 19. A shutter support member 20 is mounted for rotation within the shutter housing. The support member 20 includes a generally cylindrical central shaft 22 and a plurality of mounting members 24 fixed to the shaft 22. The upper end of a rolling shutter curtain 30 is coupled to one or more of the mounting members 24. The shutter 30 is composed of a plurality of individual, elongate slats 32. The slats 32, each of which may have a curved cross-section to facilitate wrapping around the shutter support member 20, and may be composed of steel, aluminum, or other appropriate material, are interconnected by a plurality of hinges 34, each of which joins together a pair of adjacent slats 32. The ends of the slats 32 are disposed within a pair of shutter tracks 40.

The shutter assembly 10may be manually driven, and may include a gear housing 42 at one of the end caps 14 containing a gear assembly connected to the rotatable shaft 22 to rotate the shaft 22 in either direction to raise and lower the shutter curtain 30. The gear assembly may include a drive shaft having a connection portion extending partially out of the shutter housing. A removable hand crank pole 44 configured to attach to the connection portion of the drive shaft is provided for rotation of the drive shaft to raise and lower the shutter curtain 30. The hand crank pole 44 is attached to the connection portion of the drive shaft and rotated to raise or lower the shutter curtain, and is then disconnected and stored for later use. When the shutter curtain 30 is not in use, it is rolled up on the shutter support member 20 via the hand crank pole 44 until a base slat 46 and its base plate 48 are disposed at the shutter housing.

FIGS. 2 and 3 show alternate installations of the shutter assembly 10 based on the openings covered by the shutter curtain 30. FIG. 2 illustrates the installation of the shutter assembly 10 at a store counter or other opening where the shutter housing will be accessible and disposed on the inside when the shutter curtain 30 is closed. The connection portion of the drive shaft extends out of the bottom wall 19 of the shutter housing, and includes a male connector 50 connected to the drive shaft by a universal joint 52. The hand crank pole 44 is formed from a plurality of elongated pole sections 54-58 connected by in series by hinges 60, 62. The hinges 60, 62 allow the pole sections 54-58 to pivot relative to each other with the bottom pole section 58 forming a handle with grip 64 and the intermediate pole section 56 forming a torque arm for rotating the hand crank pole 44 around the longitudinal axis of the upper pole section 54 when force is applied to the pole section 58. A second grip 66 is provided proximate the hinge 60 for grasping by the operator during use. A female connector or bell 68 is connected to the end of the pole section 54 opposite the hinge 60 and is configured to receive and engage the male connector 50 to operatively connect the hand crank pole 44 to the drive shaft. When the pole 44 is not connected, the male connector 50 hangs generally vertically downward. The bell 68 receives the male connector 50, and then the universal joint 52 allows the male connector 50 and pole 54 to be rotate to a convenient angle with respect to a vertical line for the operator turn the pole 44 and, correspondingly, the drive shaft to raise or lower the shutter curtain 30.

FIG. 3 shows a through wall style installation when the shutter housing is mounted to a wall 70 on the exterior of the opening and the shutter curtain 30 is raised and lowered from inside the structure. The drive shaft 72 is connected to the gear assembly 74 and extends through the rear wall 18 of the shutter housing and the wall 70 to the interior of the structure. The male connector 50 and universal joint 52 are operatively connected to the drive shaft 72 by a second universal joint 74 and intermediate connector 76 extending outwardly and downwardly from the wall 70, thereby allowing the male connector 50 to hang downwardly with clearance for attachment of the hand crank pole 44. The pole 44 may then be connected to the male connector 50 in a similar manner and turned to raise and lower the shutter curtain 30.

The universal joint 52 is typically designed for optimal use and minimal wear with an angle of zero degrees with respect to vertical in the joint 52 as shown in the installations in FIGS. 2 and 3 with the hand crank pole 44 directly under the joint 52. Failures of the universal joint 52 increase when the operator tilts the pole 44 to the front or sides, which increases the angle of operation in the joint 52. Tilting of the pole 44 is common where counters, furniture or other obstructions prevent make it inconvenient or impossible vertically align and turn the pole 44. The maximum recommended angle of operation is approximately 30 degrees, after which the yokes of the universal joint 52 catch on each other enough to impede rotation. The universal joint 52 continues to operate up to an angle of 45 degrees, but not well due to mechanical interference. As the angle of operation increases beyond 45 degrees, the yokes interfere mechanically with each other, causing the yokes to fail around the pinhole and releasing the pin and block within the yokes and breaking the connection.

The costs associated with these broken universal joints 52 are twofold. First, the cost of the replacement part or parts is incurred. Since most installations have a plurality of shutter assemblies 10 installed, many universal joints 52 may require replacement each year. Second, for most installations the vendor of the shutter assemblies 10 is responsible for replacing the damaged universal joints 52 within the warranty period, and therefore incurs the labor costs for a service technician to travel to the customer's location and install the new part. For these reasons, a need exists for an improved manual shutter deployment mechanism that is less expensive to replace the components when a failure occurs.

### SUMMARY OF THE INVENTION

The present invention is directed to a rolling protective shutter having an improved manual drive mechanism. According to one aspect of the present invention, a manual drive mechanism may be provided for a rolling shutter assembly having a drive shaft operatively connected to a shutter support member to rotate the shutter support member to roll up and unroll a shutter curtain in a shutter housing. The drive mechanism may include a male connector connected to the drive shaft and disposed external to the shutter housing, and a hand crank pole. The hand crank pole may include an elongated pole section, a female connector configured to demountably attach to the male connector, a universal joint operatively connecting the female connector to an end of the elongated pole section such that the female connector is pivotable with respect to the elongated pole section, and a resilient alignment member disposed on and engaging the universal joint. The alignment member may axially align the female connector and the elongated pole section when no force is applied tending to pivot the female connector relative to the elongated pole section. The alignment member may allow the female connector to pivot relative to the elongated pole section when a force is applied, and to return the female connector to axial alignment with the elongated pole section when the force is removed.

According to another aspect of the present invention, a hand crank pole may be provided for a rolling shutter assembly having a drive shaft operatively connected to a shutter support member to rotate the shutter support member to roll up and unroll a shutter curtain in a shutter housing. The drive shaft may have a male connector connected to the drive shaft and disposed external to the shutter housing. The hand crank pole may include an elongated pole section, a female connector configured to demountably attach to the male connector, a universal joint operatively connecting the female connector to an end of the elongated pole section such that the female connector is pivotable with respect to the elongated pole section, and a resilient alignment member disposed on and engaging the universal joint. The alignment member may axially align the female connector and the elongated pole section when no force is applied tending to pivot the female connector relative to the elongated pole section. The alignment member may allow the female connector to pivot relative to the elongated pole section when a force is applied, and to return the female connector to axial alignment with the elongated pole section when the force is removed.

The features and advantages of the invention will be apparent to those of ordinary skill in the art in view of the detailed description of the preferred embodiments, which is made with reference to the drawings, a brief description of which is provided below.

### BRIEF DESCRIPTION OF THE DRAWINGS

FIG. 1 is a perspective view of a rolling shutter assembly that can implement the present invention;

FIG. 2 is a side view of a counter-style installation of the shutter assembly of FIG. 1;

FIG. 3 is a side view of a through wall-style installation of the shutter assembly of FIG. 1;

FIG. 4 is a side view of a manual drive mechanism in accordance with the present disclosure for a shutter assembly;

FIG. 5 is a perspective view of an elastomeric sleeve for the manual drive mechanism of FIG. 4;

FIG. 6 is a perspective view of an alternative embodiment of an elastomeric sleeve for the manual drive mechanism of FIG. 4;

FIG. 7 is a perspective view of a further alternative embodiment of an elastomeric sleeve for the manual drive mechanism of FIG. 4;

FIG. 8 is a perspective view of an embodiment of a female connector for the manual drive mechanism of FIG. 4;

FIG. 9 is a perspective view of an alternative embodiment of a female connector for the manual drive mechanism of FIG. 4;

FIG. 10 is a perspective view of an alternative embodiment of a hand crank pole for the manual drive mechanism of FIG. 4;

FIG. 11 is an exploded view of the components of a further alternative embodiment of a hand crank pole for the manual drive mechanism of FIG. 4;

FIG. 12 is a plan view of a spring clip of the hand crank pole of FIG. 11; and

FIG. 13 is a side view of the assembled components of the hand crank pole of FIG. 11.

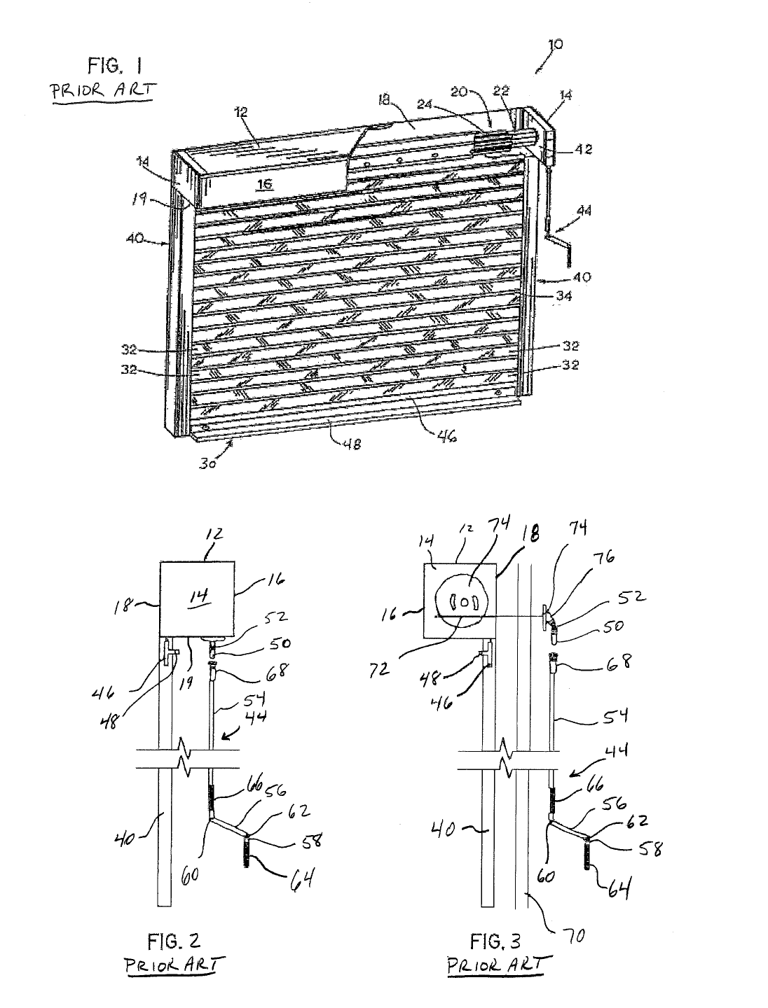

### DETAILED DESCRIPTION OF THE DRAWINGS

Although the following text sets forth a detailed description of numerous different embodiments of the invention, it should be understood that the legal scope of the invention is defined by the words of the claims set forth at the end of this patent. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

It should also be understood that, unless a term is expressly defined in this patent using the sentence “As used herein, the term ‘______ ’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

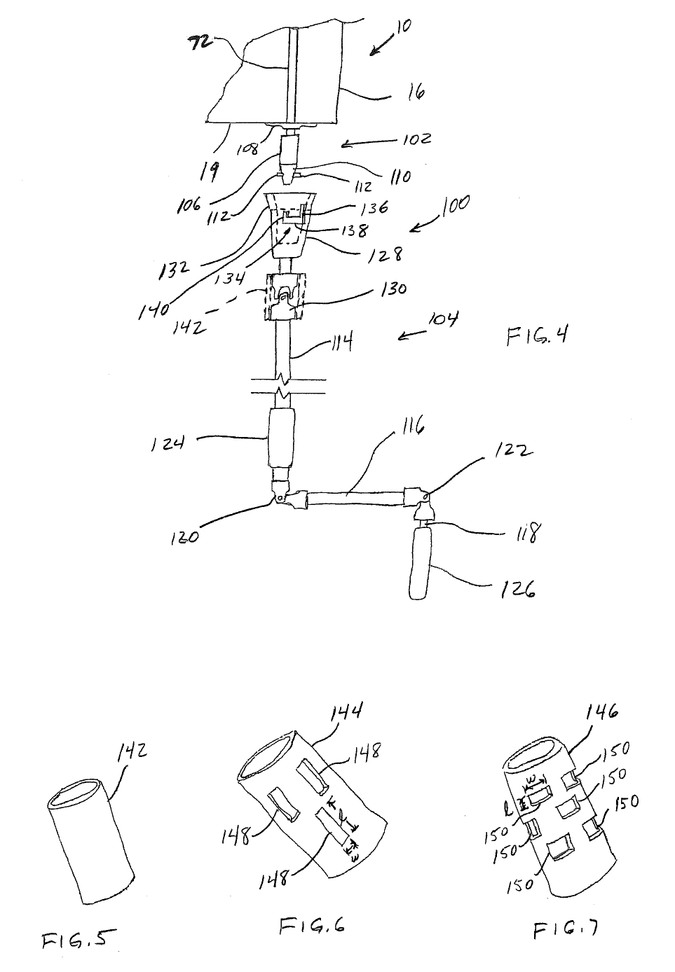

FIG. 4 illustrates one embodiment of a manual drive mechanism 100 in accordance with the present disclosure for the shutter assembly 10 discussed above. The shutter assembly 10 includes a gear assembly disposed within the shutter housing having a drive shaft 72 for raising and lowering the shutter curtain 30. The illustrated embodiment shows a counter-style installation wherein the drive shaft 72 extends downwardly through bottom wall 19 of the shutter housing. However, those skilled in the art will understand that the drive mechanism of FIG. 4 may be implemented in a through wall-style installation such as that shown in FIG. 3. The manual drive mechanism 100 includes connection portion 102 operatively connected to the drive shaft 72 and a hand crank pole 104 configure to receive and connect to the connection portion 102.

The connection portion 102 includes a male connector 106 connected to the drive shaft 72, which extends through the bottom wall 19 of the shutter housing through an alignment bracket 108. The male connector 106 may include a tapered tip 110 distal to the drive shaft 72 and at least one outwardly extending detents 112 that will be received and engaged by the connection mechanism of hand crank pole 104. In the illustrated embodiment, the male connector 106 may be rigidly connected to the drive shaft 72 so that the male connector 106 remains stationary with respect to the drive shaft 72. However, in alternative embodiments, the male connector 106 may be connected to the drive shaft 72 via a universal joint in a similar manner as discussed above such that the male connector 106 may pivot relative to the drive shaft 72.

The hand crank pole 104 may include an upper pole portion 114, an intermediate pole portion 116, and a lower pole portion 118 connected by hinges 120, 122 so that the pole portions 114-118 may be positioned as shown in FIG. 4 for turning the drive shaft 72 to roll up and unroll the shutter curtain 30. Grips 124, 126 may also be provided on the pole portion 114, 118, respectively, for grasping by the operator. At the upper end of the pole portion 114, a female connector or bell 128 may be connected to the hand crank pole 104 by a universal joint 130. The bell 128 may be a generally hollow cylinder with an upper conical end 132 dimensioned to receive the tapered tip 110 and detents 112 of the male connector 106. The bell 128 further includes generally U-shaped locking channels 134 through the outer wall of the bell 128 with each being configured to receive one of the detents 112 when the tip 110 enters the bell 128. Each locking channel 134 includes a vertical receiving section 136 extending upward into the conical end 132, a transverse section 138 extending perpendicular to a longitudinal axis of the bell 128, and a vertical locking section 140 extending upwardly but terminating below the conical end 132. When the tip 110 enters the conical end 132 of the bell 128 and the detents 112 are aligned with the receiving sections 136, the detents 112 enter the upper ends of the receiving sections 136 and slide down to the transverse sections 138. The hand crank pole 104 is then rotated so the detents 112 travel through the transverse sections 138 to the locking sections 140. The hand crank pole 104 is then moved downwardly to receive the detents 112 in the locking section 140 so that the detents 112 are engaged by the locking section 140 to rotate the male connector 106 and drive shaft 72 in either direction. After the shutter curtain 30 is moved to the desired position, the manual drive mechanism 100 is detached from the male connector 106 by lifting the hand crank pole 104 to release the detents 112 from the locking section 140, rotating the detents 112 through the transverse section 138, and sliding the detents 112 out of the receiving sections 136.

The universal joint 130 allows the bell 128 to pivot relative to the pole portions 114-118 for convenient turning of the hand crank pole 104 to raise and lower the shutter curtain 30. However, without additional support, alignment of the conical end 132 with the tip 110 of the male connector 106 is difficult to achieve with the bell 128 being pivoted out of alignment with the pole portion 114. To align the bell 128 with the pole portion 114 while still allowing the bell 128 to pivot about axis of the universal joint 130 when a force is applied, a resilient alignment member 142 (shown in broken lines) is provided. In the illustrated embodiment, the alignment member 142 is implemented in the form of an elastomeric sleeve 142 fitting snuggly about the universal joint 130. The sleeve 142 is formed from an elastomeric material and dimensioned so that the yokes of the universal joints 130 and, consequently, the bell 128 and pole portion 114 connected thereto, are aligned despite the weight of the bell 128 tending to rotate the bell 128 relative to the pole portion 114 through the universal joint 130. At the same time, the sleeve 142 is deformable to allow the pole portion 114 to be moved to an angle relative to a vertical axis after the bell 128 is connected to the male connector 106. After the shutter curtain 30 is positioned and the bell 128 is detached from the male connector 106, the sleeve 142 returns to its normal cylindrical shape and thereby rotates the bell 128 back into alignment with the pole portion 114 as shown in FIG. 4.

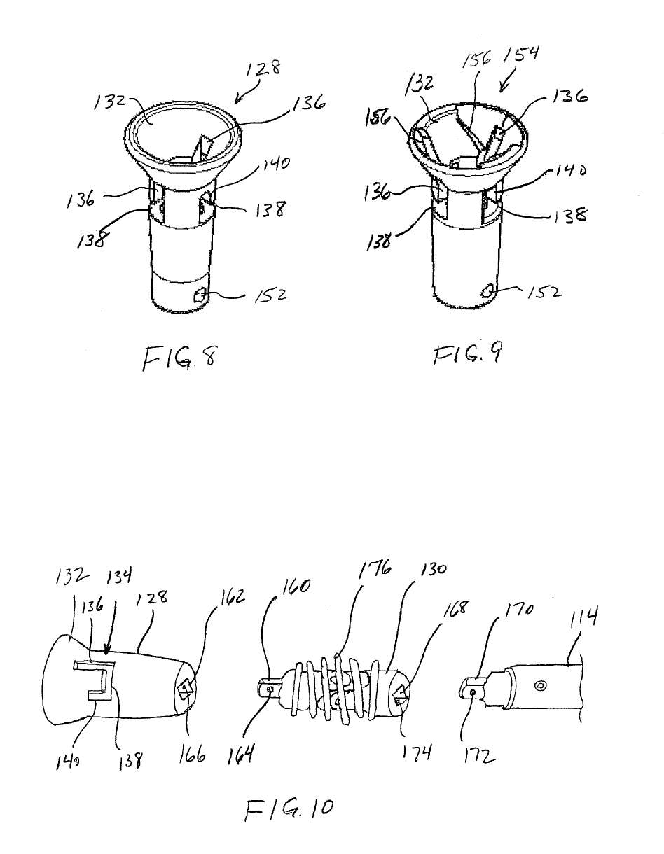

The elastomeric sleeve 142 is shown in greater detail in FIG. 5. The sleeve 142 may have a generally hollow cylindrical shape such that the sleeve 142 may be slid onto the hand crank pole 104 and over the universal joint 130. The sleeve 142 may tightly fit around the universal joint 130 to be held in place as the hand crank pole 104 is used by the operators. If necessary, an adhesive or other fastening mechanism may be use to affix the sleeve 142 in place around the universal joint 130. Depending on the dimensions of the sleeve 142 and the material used, the sleeve 142 may tend to bunch when the bell 128 is rotated about the universal joint 130. Over time, the deformation can cause the material to relax and compromise the resiliency of the sleeve 142 and its ability to align the bell 128 with the pole portion 114. FIGS. 6 and 7 illustrate alternative embodiments of elastomeric sleeves 144, 146 configured to reduce the amount of bunching and resiliency loss in the sleeves 144, 146. Referring to FIG. 6, the sleeve 144 may include a plurality of openings 148 through the outer wall. In this embodiment, the openings 148 have a longer length l in the axial direction than a width w in the circumferential direction. The removed material of the sleeve 144 reduces the amount of bunching and corresponding stress on the sleeve 144 during rotation about the axes of the universal joint 130. In the alternative embodiment of FIG. 7, the sleeve 146 may include openings 150 through the outer wall having a circumferential width w that is greater than the axial length l. These configurations of openings 148, 150 are exemplary, and those skilled in the art will understand that other opening configurations and arrangements may be implemented in manual drive mechanisms in accordance with the present disclosure.

FIG. 8 illustrates one embodiment of the bell 128 of the hand crank pole 104. The conical end 132 has an inner conical surface feeding the tapered tip 110 downwardly into the interior of the bell 128. The receiving sections 136 of the locking channels 134 extend through the inner conical surface so that sufficient space is provided for the detents 112 to enter the receiving sections 136. Contrastingly, the locking sections 140 terminate below the inner conical surface to retain the detents 112 therein. The bell 128 may further include one or more openings 152 for insertion of attachment mechanisms such as set screws to secure the bell 128 to the hand crank pole 104. In an alternate embodiment of a bell 154 shown in FIG. 9, the operator may be assisted in aligning the receiving sections 136 of the locking channels 134 with the detents 112 of the male connector 106. As the male connector 106 is typically disposed above the operator's head, the operator cannot see through the bell 128, 154 to align the detents 112 with the receiving sections 136. Alignment grooves 156 may be provided in the inner conical surface of the conical end 132 on either side of the receiving sections 136. When the tip 110 is inserted, the detents 112 are engaged by alignment grooves 156 to direct the detents 112 into the corresponding receiving sections 136.

The manual drive mechanism 100 in accordance with the present disclosure reduces the costs and time associated with repairing or replacing prior drive mechanisms. By removing the universal joint 52 from the individual shutter assemblies 10, the components of the shutter assemblies 10 require replacement less frequently than in previous shutter assemblies 10. Failures of the components will now occur in the manual drive mechanism 100, most typically in the universal joint 130 due to similar failure modes as discussed above. However, when the universal joint 130 fails, the vendor need only ship a replacement manual drive mechanism 100 to the customer, thereby saving on the expense of sending a maintenance technician out to the customer's location to make repairs.

Repair and/or replacement of failed parts may further be facilitated with a modular design of the components of the hand crank pole 104. As shown in FIG. 10, the pole portion 114, bell 128 and universal joint 130 may be configured for demountable attachment to each other. In the illustrated embodiment, socket-type connections may be provided between the upper pole portion 114 and the universal joint 130, and between the universal joint 130 and the bell 128. Consequently, the universal joint 130 may have a male socket connector 160 at one end and the bell 128 may have a corresponding female socket receptacle 162 to receive the socket connector 160. A spring-biased detent 164 may engage a corresponding recess 166 within the socket receptacle 162 to demountably retain the socket connector 160 within the socket receptacle 162. The opposite end of the universal joint 130 may include a female socket receptacle 168 for receiving a corresponding male connector 170 of the pole portion 114. The male connector 170 may include a spring-biased detent 172 that may be engaged by a corresponding recess 174 within the socket receptacle 168. With the modular configuration, the component of the hand crank pole 104 most likely to fail, the universal joint 130, may be removed and replaced without the need for replacing the entire crank pole 104. Moreover, if it is possible to orient the hand crank pole 104 vertically and turn the manual drive mechanism 100 to raise and lower the shutter curtain 30, the bell 128 may be attached directly to the pole portion 114 via the male connector 170 and socket receptacle 162 for use of the hand crank pole 104 until the replacement universal joint 130 is delivered and installed.

FIG. 10 further illustrates an alternative embodiment of an alignment member in the form of a coil spring 176. The coil spring 176 may be disposed over the universal joint 130, with the ends engaging the corresponding yokes of the universal joint 130 to retain the coil spring 176 in place. As with the sleeve 142 discussed above, the coil spring 176 may be stiff enough to align the bell 128 with the pole portion 114 against the weight of the bell 128, and flexible enough to allow the pole portion 114 to be oriented at an angle with respect to a vertical axis after the bell 128 is connected to the male connector 106. Of course, those skilled in the art will understand that other alignment members and mechanisms may be implemented in hand crank poles 104 in accordance with the present disclosure, and the use of such members and mechanism is contemplated by the inventors.

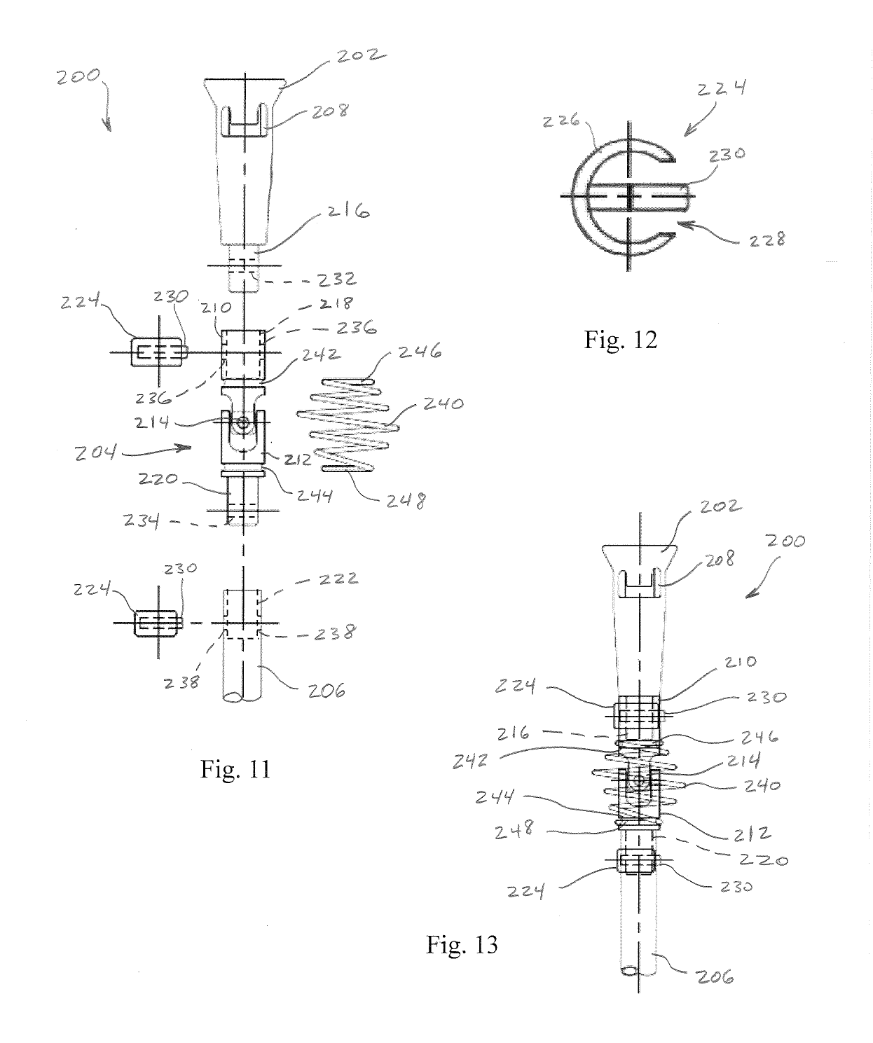

FIGS. 11-13 illustrate a further alternative embodiment of a hand crank pole 200 in accordance with the present disclosure. Referring to FIG. 11, the hand crank pole 200 may include a bell 202, a universal joint 204 and a pole portion 206 that are generally similar to the corresponding elements described above. The bell 202 may have a locking channel 208, and the universal joint 204 may include an upper portion 210 and a lower portion 212 connected by universal hinges 214. In the illustrated embodiment, modular connections between the bell 202 and the universal joint 204, and the universal joint 204 and the pole portion 206, may be implemented but with the elements reversed from the embodiment shown in FIG. 10. Consequently, the bell 202 may have a male connector 216 at one end and the upper portion 210 of the universal joint 204 may have a corresponding female recess 218 to receive the connector 216. The lower portion 212 of the universal joint 204 may include a male connector 220 that may be received by a corresponding female recess 222 of the pole portion 206.

When the connectors 216, 220 are inserted into the recesses 218, 222, respectively, the parts may be held together via spring clips 224, 224. As shown in FIG. 12, each spring clip 224 may include a semi-circular ring 226 shaped to correspond to the shapes of the upper portion 210 of the universal joint 204 and the pole portion 206. The ring 226 may have an open end 228 having a width that is smaller than the outer diameters of the upper portion 210 and pole portion 206 so that the ring 226 may be press fit onto the upper portion 210 and pole portion 206 and retained thereon. The spring clip 224 may further include a locking bar 230 extending from an inner surface of the ring 226 and through the opening 228. Returning to FIG. 11, the male connectors 216, 220 may have bores 232, 234, respectively, and the upper portion 210 and pole portion 206 may have apertures 236, 238, respectively, that are shaped to receive the locking bars 230 of the spring clips 224. For example, after the connector 216 is inserted into the recess 218, the locking bar 230 may be inserted through the apertures 236 and bore 232 and the ring 226 may partially encircle the upper portion 210 to lock the bell 202 to the upper portion 210 of the universal joint 204 as shown in FIG. 13. The pole portion 206 is similarly locked on to the lower portion 212 with the locking bar 230 is inserted through the apertures 238 and bore 234.

FIG. 11 further illustrates that the universal joint 204 may be configured for attachment and alignment of a spring 240. The upper portion 210 of the universal joint 204 may have an annular groove 242 in the outer surface, and the lower portion 212 may have a similar annular groove 244. The annular grooves 242, 244 may be configured to receive an upper coil 246 and a lower coil 248, respectively, of the spring 240. Before the bell 202 and/or the pole portion 206 are connected to the universal joint 204, the spring 240 may be slid onto the upper portion 210 and lower portion 212 of the universal joint 204. The spring 240 may then be positioned so that the upper coil 246 is disposed within the annular groove 242 and the lower coil 248 is disposed within the annular groove 244 as shown in FIG. 13. As discussed above for the coil spring 176, the spring 240 may be stiff enough to align the bell 202 with the pole portion 206 against the weight of the bell 202, and may be flexible enough to allow the pole portion 206 to be oriented at an angle with respect to a vertical axis after the bell 202 is connected to the upper portion 210 of the universal joint 204.

While the preceding text sets forth a detailed description of numerous different embodiments of the invention, it should be understood that the legal scope of the invention is defined by the words of the claims set forth at the end of this patent. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

What is claimed is:

1. A manual drive mechanism for a rolling shutter assembly having a drive shaft operatively connected to a shutter support member to rotate the shutter support member to roll up and unroll a shutter curtain in a shutter housing, the manual drive mechanism comprising:
a male connector connected to the drive shaft and disposed external to the shutter housing;
a hand crank pole comprising:
an elongated pole section,
a female connector configured to demountably attach to the male connector,
a universal joint operatively connecting the female connector to an end of the elongated pole section such that the female connector is pivotable with respect to the elongated pole section, and
a resilient alignment member disposed on and engaging the universal joint, wherein the resilient alignment member axially aligns the female connector and the elongated pole section when no force is applied tending to pivot the female connector relative to the elongated pole section, and the resilient alignment member allows the female connector to pivot relative to the elongated pole section when a force is applied and returns the female connector to axial alignment with the elongated pole section when the force is removed.

2. The manual drive mechanism as defined in claim 1, wherein the resilient alignment member comprises a hollow elastomeric sleeve disposed over and engaging the universal joint.

3. The manual drive mechanism as defined in claim 2, wherein the hollow elastomeric sleeve includes a plurality of openings through an outer wall of the hollow elastomeric sleeve.

4. The manual drive mechanism as defined in claim 3, wherein the openings are rectangular openings each having a length l in an axial direction of the hollow elastomeric sleeve that is greater than a circumferential width w.

5. The manual drive mechanism as defined in claim 1, wherein the resilient alignment member comprises a coil spring disposed over and engaging the universal joint.

6. The manual drive mechanism as defined in claim 1, wherein the female connector comprises a conical end receiving the male connector therein.

7. The manual drive mechanism as defined in claim 6, wherein the male connector comprises at least one detent extending radially outwardly from an outer surface of the male connector, and the female connector comprises at least one locking channel through an outer wall of the female connector, wherein the locking channel receives and retentively engages a corresponding detent of the male connector so that the male connector and the drive shaft rotate when the hand crank pole is connected and turned by an operator.

8. The manual drive mechanism as defined in claim 7, wherein a receiving section of the locking channel exends axially upwardly and intersects an inner conical surface of the conical end, and a locking section of the locking channel extends axially upwardly and terminates below the conical end.

9. The manual drive mechanism as defined in the claim 7, wherein an inner conical surface of the conical end comprises an alignment groove corresponding to each locking channel and engaging the corresponding detent of the male connector to direct the detent into the locking channel.

10. The manual drive mechanism as defined in claim 1, wherein the universal joint is demountably attached to the female connector and the elongated pole section.

11. A hand crank pole for a rolling shutter assembly having a drive shaft operatively connected to a shutter support member to rotate the shutter support member to roll up and unroll a shutter curtain in a shutter housing, wherein the drive shaft has a male connector connected to the drive shaft and disposed external to the shutter housing, the hand crank pole comprising:
an elongated pole section;
a female connector configured to demountably attach to the male connector;
a universal joint operatively connecting the female connector to an end of the elongated pole section such that the female connector is pivotable with respect to the elongated pole section; and
a resilient alignment member disposed on and engaging the universal joint, wherein the resilient alignment member axially aligns the female connector and the elongated pole section when no force is applied tending to pivot the female connector relative to the elongated pole section, and the resilient alignment member allows the female connector to pivot relative to the elongated pole section when a force is applied and returns the female connector to axial alignment with the elongated pole section when the force is removed.

12. The hand crank pole as defined in claim 11, wherein the resilient alignment member comprises a hollow elastomeric sleeve disposed over and engaging the universal joint.

13. The hand crank pole as defined in claim 12, wherein the hollow elastomeric sleeve includes a plurality of openings through an outer wall of the hollow elastomeric sleeve.

14. The hand crank pole as defined in claim 13, wherein the openings are rectangular openings each having a length l in an axial direction of the hollow elastomeric sleeve that is greater than a circumferential width w.

15. The hand crank pole as defined in claim 11, wherein the resilient alignment member comprises a coil spring disposed over and engaging the universal joint.

16. The hand crank pole as defined in claim 11, wherein the female connector comprises a conical end receiving the male connector therein.

17. The hand crank pole as defined in claim 16, wherein the male connector has at least one detent extending radially outwardly from an outer surface of the male connector, and the female connector comprises at least one locking channel through an outer wall of the female connector, wherein the locking channel receives and retentively engages a corresponding detent of the male connector so that the male connector and the drive shaft rotate when the hand crank pole is connected and turned by an operator.

18. The hand crank pole as defined in claim 17, wherein a receiving section of the locking channel extends axially upwardly and intersects an inner conical surface of the conical end, and a locking section of the locking channel extends axially upwardly and terminates below the conical end.

19. The hand crank pole as defined in the claim 17, wherein an inner conical surface of the conical end comprises an alignment groove corresponding to each locking channel and engaging the corresponding detent of the male connector to direct the detent into the locking channel.

20. The hand crank pole as defined in claim 11, wherein the universal joint is demountably attached to the female connector and the elongated pole section.
